(19) United States
(12) Patent Application Publication
(10) Pub. No.: US 2014/0092324 A1
(43) Pub. Date: Apr. 3, 2014

(54) TRANSPARENT CONDUCTIVE SUBSTRATE AND TOUCH PANEL HAVING THE SAME

(71) Applicant: SAMSUNG CORNING PRECISION MATERIALS CO., LTD., Gumi-si, (KR)

(72) Inventors: Eui Soo KIM, Asan-si (KR); Seung Won PARK, Asan-si (KR)

(73) Assignee: SAMSUNG CORNING PRECISION MATERIALS CO., LTD., Gumi-si (KR)

(21) Appl. No.: 14/039,753

(22) Filed: Sep. 27, 2013

(30) Foreign Application Priority Data
Sep. 28, 2012 (KR) 10-2012-0108927

(51) Int. Cl. G02F 1/1333

(52) U.S. Cl. CPC G02F 1/13338
USPC 349/12; 174/258; 174/257

(57) ABSTRACT

A transparent conductive substrate used for the detection of a touched position in a touch screen panel and a touch panel having the same. The transparent conductive substrate includes a base substrate, a transparent conductive layer formed on the base substrate, the transparent conductive layer including a pattern part which includes a transparent conductive film coating the base substrate and a non-pattern part through which the base substrate is exposed, and a polymer resin layer containing a resin that has a refractive index from 1.4 to 1.6, the polymer resin layer being formed on the transparent conductive layer while filling the non-pattern part, the thickness of the polymer resin layer from the pattern part ranging from 1 to 1000 μm. The transparent conductive film includes a first thin film on the base substrate, a metal thin film on the first thin film, and a second thin film on the metal thin film.

### CROSS REFERENCE TO RELATED APPLICATION

The present application claims priority from Korean Patent Application Number 10-2012-0108927 filed on Sep. 28, 2012, the entire contents of which are incorporated herein for all purposes by this reference.

### BACKGROUND OF THE INVENTION

1. Field of the Invention

The present invention relates to a transparent conductive substrate and a touch panel having the same, and more particularly, to a transparent conductive substrate which is used for the detection of a touched position in a touch screen panel (TSP) and a touch panel having the same.

2. Description of Related Art

In general, a touch panel refers to a device that is disposed on the surface of a display device, such as a cathode ray tube (CRT), a liquid crystal display (LCD), a plasma display panel (PDP), an electroluminescence (EL) device or the like, such that a signal can be outputted when a user touches the touch panel with a finger or an input device such as a stylus while watching the screen of the display device. Recently, the touch panel is widely used in a variety of electronic devices, such as a personal digital assistant (PDA), a notebook computer, an optical amplifier (OA) device, a medical instrument or a car navigation system.

Such touch panels are divided into a resistance film type, a capacitance type, an ultrasonic wave type, an infrared (IR) radiation type and the like depending on the technology of detecting a position.

The resistance film type is configured such that two substrates each of which is coated with a transparent electrode layer (an indium tin oxide (ITO) film) are joined together so that the transparent electrode layers face each other on both sides of a dot spacer. When a finger, a pen or the like touches the upper substrate, a signal for detecting the position is applied. When the upper substrate adjoins the transparent electrode layer of the lower substrate, the position is detected by detecting the electrical signal. The advantages of this technology are a high response rate and economical competitiveness, whereas the disadvantages are low endurance and fragility.

The capacitance type is configured such that a transparent electrode is formed by coating one surface of a substrate film of a touch screen sensor with a conductive metal material, in which a certain amount of current is allowed to flow along the glass surface. When a user touches the screen, a touched position is detected by recognizing a position where the amount of current is changed due to the capacitance of the human body and calculating the size. The advantages of this technology are superior endurance and high transmittance, whereas the disadvantage is that it is difficult to operate the touch panel with a pen or a gloved hand since this technology uses the capacitance of the human body.

The ultrasonic wave type uses a piezoelectric device which is based on a piezoelectric effect, and detects the position by calculating the distance from each input point by generating surface waves in the X and Y directions in an alternating fashion from the piezoelectric device in response to touching of the touch panel. While this technology realizes a high definition and a high light transmittance, the drawbacks are that the sensor is vulnerable to contamination and liquid.

The IR radiation type has a matrix structure in which a plurality of light-emitting devices and a plurality of photodetectors are disposed around a panel. When light is interrupted by a user, input coordinates are determined by acquiring X and Y coordinates of the interrupted position. While this technology has a high light transmittance and strong endurance to external impacts and scratches, the drawbacks are the large size, the poor identification of an inaccurate touch and the slow response rate.

The capacitance type is most popular among these technologies. These technologies use a transparent conductive film made of, for example, indium tin oxide (ITO) in order to detect the touched position.

The transparent conductive thin film is patterned in order to detect the touched position. However, the patterning causes a problem in that the reflectance of the pattern part differs from the reflectance of the non-pattern part such that the shape of the pattern can be visually recognized. In order to reduce the difference in the reflectance between the pattern and non-pattern parts to a value of 1% or less, preferably, 0.5% or less, an index matching layer is situated between a window cover glass and the transparent conductive thin film. The index matching layer generally includes a middle-refractive index thin film made of Nb₂O₅ and a low-refractive index thin film made of SiO₂.

In the meantime, the increased area of the display increases the length of electrical lines which are in use for the detection of the touched position. This consequently requires a transparent conductive thin film that has better electrical conductivity. In an example, a transparent conductive film which is used in a mobile phone, such as a cellular phone or a smart phone, is required to have a sheet resistance ranging from about 170Ω to about 250Ω. On the other hand, a transparent conductive film for a tablet computer is required to have a sheet resistance of about 120Ω, and a transparent conductive film for a monitor is required to have a sheet resistance of about 50Ω or less.

In order to realize a transparent conductive thin film having a low resistance characteristic, the thickness of the transparent conductive thin film can be increased. In this case, however, the pattern is visually recognizable even after the index matching layer is situated between the window cover glass and the transparent conductive thin film, which is problematic.

The information disclosed in the Background of the Invention section is provided only for better understanding of the background of the invention, and should not be taken as an acknowledgment or any form of suggestion that this information forms a prior art that would already be known to a person skilled in the art.

### BRIEF SUMMARY OF THE INVENTION

Various aspects of the present invention provide a transparent conductive substrate that has a high transmittance while having low-resistance and non-visibility characteristics and a touch pane having the same.

In an aspect of the present invention, provided is a transparent conductive substrate that includes: a base substrate; a transparent conductive layer formed on the base substrate, the transparent conductive layer including a pattern part which includes a transparent conductive film coating the base substrate and a non-pattern part through which the base substrate is exposed; and a polymer resin layer containing a resin that has a refractive index ranging from 1.4 to 1.6, the polymer resin layer being formed on the transparent conductive layer while filling the non-pattern part, the thickness of the polymer resin layer from the pattern part ranging from 1 to 1000 μm. The transparent conductive film includes: a first thin film formed on the base substrate, the refractive index of the first thin film ranging from 2.1 to 2.7, and the thickness of the first thin film ranging 30 to 50 nm; a metal thin film formed on the first thin film, the thickness of the metal thin film ranging from 5 to 15 nm; and a second thin film formed on the metal thin film, the refractive index of the second thin film ranging from 2.1 to 2.7, and the thickness of the second thin film ranging 30 to 50 nm.

According to an exemplary embodiment of the present invention, each of the first and second thin films may contain at least one selected from the group consisting of Nb₂O₅, TiO₂ and Ta₂O₅.

The metal thin film may be made of Ag or a Ag alloy, the thickness of the metal thin film ranging from 8 to 12 nm.

The polymer resin layer may be made of acrylic resin or epoxy resin.

The difference in reflectance between the pattern part and the non-pattern part may be 1% or less.

The light absorptance of the transparent conductive substrate may be 5% or less.

The transparent conductive substrate may further include a planarization layer formed between the first thin film and the metal thin film, the planarization layer planarizing the first thin film. Here, the planarization layer may be made of ZnO, the thickness of the planarization layer ranging from 3 to 7 nm, the total thickness of the first thin film and the planarization layer ranging from 30 to 50 nm.

The transparent conductive substrate may further include an anti-oxidation layer formed between the metal thin film and the second thin film, the anti-oxidation layer preventing the metal thin film from being oxidized. The anti-oxidation layer may be made of ZnO, the thickness of the anti-oxidation layer ranging from 3 to 7 nm, and the total thickness of the second thin film and the anti-oxidation layer ranging from 30 to 50 nm.

Also provided is a touch panel that includes the above-described transparent conductive substrate.

According to embodiments of the present invention, the transparent conductive substrate has a low-resistance characteristic of 20Ω or less, a non-visibility characteristic in which the difference in reflectance between the pattern part and the non-pattern part is 1% or less, and a high transmittance.

In addition, the transparent conductive substrate according to the present invention can be easily fabricated, and has excellent productivity due to a fast coating speed.

Furthermore, the fabrication cost of the transparent conductive substrate according to the present invention is inexpensive since expensive indium tin oxide (ITO) is not used.

The methods and apparatuses of the present invention have other features and advantages which will be apparent from, or are set forth in greater detail in the accompanying drawings, which are incorporated herein, and in the following Detailed Description of the Invention, which together serve to explain certain principles of the present invention.

### BRIEF DESCRIPTION OF THE DRAWINGS

FIG. 1 is a schematic cross-sectional view showing a transparent conductive substrate according to an embodiment of the present invention.

### DETAILED DESCRIPTION OF THE INVENTION

Reference will now be made in detail to a transparent conductive substrate and a touch panel having the same according to the present invention, embodiments of which are illustrated in the accompanying drawings and described below, so that a person having ordinary skill in the art to which the present invention relates can easily put the present invention into practice.

Throughout this document, reference should be made to the drawings, in which the same reference numerals and signs are used throughout the different drawings to designate the same or similar components. In the following description of the present invention, detailed descriptions of known functions and components incorporated herein will be omitted when they may make the subject matter of the present invention unclear.

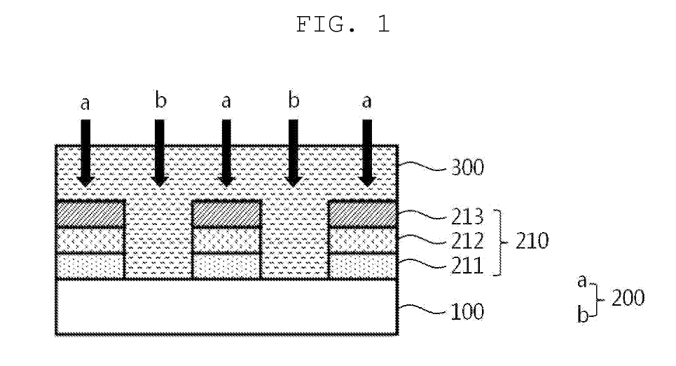

FIG. 1 is a schematic cross-sectional view showing a transparent conductive substrate according to an embodiment of the present invention.

Referring to FIG. 1, a transparent conductive substrate according to an exemplary embodiment of the present invention includes a base substrate 100, a transparent conductive layer 200 and a polymer resin layer 300.

The base substrate 100 serves as a cover glass of a touch panel, and can be made of a glass, preferably, a chemically toughened glass. The thickness of the glass can be typically 1 mm or less, and the glass can be made of high-transmittance soda-lime or alkali-free aluminosilicate. While the glass has physical properties that overcome the problems of plastic materials involving transmittance, long-term endurance, touch sensation and the like, it has a drawback of being vulnerable to impacts. A touch panel is attached to a display part of a variety of instruments. In particular, when attached to a mobile phone or the like which is small and thin, the touch panel is required to be strong enough such that it can realize endurance to external impacts. Accordingly, it is preferable to use a chemically toughened glass that is produced from a soda-lime glass by chemical treatment of substituting Na with K in order to increase strength. It is more preferable that the base substrate 100 be implemented as a flexible glass and the thickness thereof be 0.1 mm or less.

The transparent conductive layer 200 is formed on the base substrate 100, and includes a pattern part “a” which includes a transparent conductive film 210 coating the base substrate and a non-pattern part “b” through which the base substrate 100 is exposed.

The transparent conductive layer 200 can act as an electrode for detecting a touch position when the transparent conductive substrate according to the present invention is used in a touch panel.

The transparent conductive film 210 includes a first thin film 211 formed on the base substrate 100, a metal thin film 212 formed on the first thin film 211 and a second thin film 213 formed on the metal thin film 212. The refractive index of the first thin film 211 ranges from 2.1 to 2.7, and the thickness of the first thin film 211 ranges from 30 to 50 nm. The thickness of the metal thin film 212 ranges from 5 to 15 nm. The refractive index of the second thin film 213 ranges from 2.1 to 2.7, and the thickness of the second thin film 213 ranges from 30 to 50 nm.

Here, the first thin film 211 and the second thin film 213 can contain Nb₂O₅ or TiO₂.

In addition, the thickness of the metal thin film 212 can range from 8 to 12 nm, and the metal thin film 212 can be made of Ag or a Ag alloy. When the thickness of the metal thin film made of Ag or a Ag alloy exceeds 12 nm, the light absorptance of the metal thin film 212 exceeds 2%, which in turn decreases the transmittance of the transparent conductive substrate. The transparent conductive substrate then becomes inappropriate for use in a touch panel.

The patterning process for forming the pattern part “a” and the non-pattern part “b” of the conductive layer 200 can include coating the base substrate 100 with the first thin film 211, the metal thin film 212 and the second thin film 213 by direct current (DC) magnetron sputtering, laminating the second thin film 213 with a dry film photoresist, placing a pattern film in which predetermined pattern elements continuously intersect each other on the dry film photoresist, forming a dry film photoresist area by irradiating the dry film photoresist with ultraviolet (UV) radiation, and selectively peeling off the dry film photoresist area that has been irradiated with the UV radiation using an acidic or alkaline etching solution.

In the pattern part “a” and the non-pattern part “b” produced as such, the difference in refractive index between the pattern part “a” and the non-pattern part “b” can be 1% or less, and preferably, 0.5% or less.

The polymer resin layer 300 is made of a resin that has a refractive index ranging from 1.4 to 1.6. The polymer resin layer 300 is formed on the transparent conductive layer 200 while filling the non-pattern part “b” and is formed such that the thickness from the pattern part “a” ranges from 1 to 1000 μm. That is, the polymer resin layer 300 is formed by coating the transparent conductive layer 200 with the resin such that the resin fills the non-pattern part “b” and the thickness of the resin from the pattern part “a” ranges from 1 to 1000 μm. The polymer resin layer is formed to that thickness only for convenience with respect to the process. The characteristics of the transparent conductive substrate according to the present invention are not greatly influenced when the thickness of the polymer resin layer is 1 μm or greater.

The polymer resin layer 300 can be made of an acrylic resin or an epoxy resin. The polymer resin layer 300 can be formed by coating the transparent conductive layer 200 which includes the pattern part “a” and the non-pattern part “b” with a polymer resin by a doctor blade method.

As described above, the present invention controls and optimizes the refractive indices and thicknesses of the glass (base substrate), the transparent conductive layer coating the glass and the resin layer. Accordingly, the transparent conductive substrate has a low-resistance characteristic of 20Ω or less, preferably, 10Ω or less, a non-visibility characteristic in which the difference in refractive index between the pattern part “a” and the non-pattern part “b” is 1% or less, and a higher transmittance. That is, the transparent conductive substrate according to the present invention can have the same function as a related-art transparent conductive substrate having an index matching layer coated with indium tin oxide (ITO) which is for use in a touch panel. In addition, compared to the related-art transparent conductive substrate, the transparent conductive substrate according to the present invention is easy to fabricate, has high productivity due to a fast coating speed, and can reduce fabrication cost since it does not use expensive ITO.

In addition, in order for the transparent conductive substrate according to the present invention to be used for a display that requires high transmission, the light absorptance of the transparent conductive substrate is 5% or less, preferably, 3% or less.

In addition, the transparent conductive substrate according to the present invention can also include a planarization layer (not shown) which is formed between the first thin film 211 and the metal thin film 212, and planarizes the first thin film 211.

The planarization layer (not shown) planarizes the firs thin film 211, and improves the conductivity of the metal thin film 212. Here, the planarization layer (not shown) can be made of ZnO, with the thickness ranging from 3 to 7 nm.

In addition, the transparent conductive substrate according to the present invention can also include an anti-oxidation layer (not shown) which is formed between the metal thin film 212 and the second thin film 213, and prevents the metal thin film 212 from being oxidized.

The anti-oxidation layer (not shown) prevents the metal thin film 212 from being oxidized and the conductivity thereof from decreasing in the process in which the second thin film 213 is formed. The anti-oxidation layer can be made of ZnO, with the thickness ranging from 3 to 7 nm.

Reference will now be made in more detail to some examples of the present invention. It should be understood, however, that the following examples are illustrative only and are not intended to limit the scope of the present invention.

### EXAMPLE 1

A transparent conductive substrate according to Example 1 includes a glass substrate, a first thin film which is formed on the glass substrate with a thickness of 31 nm and is made of Nb₂O₅, a planarization layer which is formed on the first thin film with a thickness of 5 nm and is made of ZnO, a metal thin film which is formed on the planarization layer with a thickness of 10 nm and is made of Ag, an anti-oxidation layer which is formed on the metal thin film with a thickness of 5 nm and is made of ZnO, a second thin film which is formed on the anti-oxidation layer with a thickness of 31 nm and is made of Nb₂O₅, and a resin layer which is formed on the second thin film with a thickness of 5 μm. Here, the resin layer is formed using Samyang EMS SOC 3006U resin.

### EXAMPLE 2

A transparent conductive substrate according to Example 2 has the same configuration as that of Example 1, except for a first thin film which is made of Ta₂O₅ and has a thickness of 35 nm and a second thin film which is made of Ta₂O₅ and has a thickness of 36 nm.

### COMPARATIVE EXAMPLE 1

A transparent conductive substrate according to Comparative Example 1 has the same configuration as that of Example 1, except for a first thin film which is made of Ta₂O₅ with a thickness of 38 nm, a second thin film which is made Ta₂O₅ of with a thickness of 40 nm, and a metal thin film which is made of Ag with a thickness of 12 nm.

### COMPARATIVE EXAMPLE 2

A transparent conductive substrate according Comparative Example 2 includes a middle-refractive index thin film which is formed on a glass substrate with a thickness of 14 nm and is made of Nb₂O₅, a low-refractive index thin film which is formed on the middle-refractive index thin film with a thickness of 40 nm and is made of SiO₂, a transparent conductive film which is formed on the low-refractive index thin film with a thickness of 50 nm and is made of ITO, and a polymer resin layer which is formed on the transparent conductive film with a thickness of 5 μm. Here, the polymer resin layer is formed using Samyang EMS SOC 3006U resin.

Table 1 presents the transmission characteristics, reflectance, visibility and sheet resistance of the transparent conductive substrate according to Examples 1 and 2 and Comparative Examples 1 and 2.

TABLE 1

| | Transmission | | | | | |
|---|---|---|---|---|---|---|
| | characteristics | | Reflectance (%) | | | |
| | T¹ | AB² | Rf³ | ARf⁴ | VIS⁵ | SR⁶ (Ohm) |
| Ex. 1 | 90.0% | 1.9% | 8.1% | 0.1% | 0.1% | 8 |
| Ex. 2 | 89.8% | 2.1% | 8.2% | 0.2% | 0.2% | 8 |
| Comp. Ex. 1 | 79.2% | 12.7% | 11.4% | 3.4% | 3.4% | 5.5 |
| Comp. Ex. 2 | 84.2% | 7.7% | 9.8% | 1.7% | 1.7% | 60 |
| Glass | 91.9% | — | 8.1% | — | | Not |
| | | | | | | conductive |

Note)
T¹: Transmittance,
AB²: Absorptance with respect to glass,
Rf³: Reflectance,
ARf⁴: Actual reflectance with respect to glass,
VIS⁵: Visibility,
SR⁶: Sheet resistance

In Table 1, the visibility is a value obtained by measuring the difference in reflectance between the pattern part and the non-pattern part after forming the pattern part and the non-pattern part by patterning the multilayer film except for the polymer resin layer, followed by forming the polymer resin layer on the multilayer film by disposing resin in the non-pattern part.

As presented in Table 1, in the transparent conductive layer according to the present invention, the difference in reflectance between the pattern part and the non-pattern part is a very small value of 0.2% or less while the sheet resistance is 10Ω or less. It is also apparent that the transparent conductive layer has a high transmittance of about 90%. In contrast, as for Comparative Example 1 that has a similar structure to a traditional low-E structure, the transmittance and the visibility are inferior to those of the present invention. In addition, as for Comparative Example 2 that has a similar structure to a traditional transparent conductive substrate in use for a touch panel, the transmittance and the visibility are inferior to those of the present invention, and the sheet resistance is very high.

The foregoing descriptions of specific exemplary embodiments of the present invention have been presented with respect to the drawings. They are not intended to be exhaustive or to limit the present invention to the precise forms disclosed, and obviously many modifications and variations are possible for a person having ordinary skill in the art in light of the above teachings.

It is intended therefore that the scope of the present invention not be limited to the foregoing embodiments, but be defined by the Claims appended hereto and their equivalents.

What is claimed is:

1. A transparent conductive substrate comprising:
a base substrate;
a transparent conductive layer formed on the base substrate, the transparent conductive layer including a pattern part which includes a transparent conductive film coating the base substrate and a non-pattern part through which the base substrate is exposed; and
a polymer resin layer comprising a resin, a refractive index of the resin ranging from 1.4 to 1.6, the polymer resin layer being formed on the transparent conductive layer while filling the non-pattern part, a thickness of the polymer resin layer from the pattern part ranging from 1 to 1000 μm,
wherein the transparent conductive film comprises:
a first thin film formed on the base substrate, a refractive index of the first thin film ranging from 2.1 to 2.7, and a thickness of the first thin film ranging 30 to 50 nm;
a metal thin film formed on the first thin film, a thickness of the metal thin film ranging from 5 to 15 nm; and
a second thin film formed on the metal thin film, a refractive index of the second thin film ranging from 2.1 to 2.7, and a thickness of the second thin film ranging 30 to 50 nm.

2. The transparent conductive substrate of claim 1, wherein each of the first and second thin films comprises at least one selected from the group consisting of Nb₂O₅, TiO₂ and Ta₂O₅.

3. The transparent conductive substrate of claim 1, wherein the metal thin film comprises Ag or a Ag alloy, a thickness of the metal thin film ranging from 8 to 12 nm.

4. The transparent conductive substrate of claim 1, wherein the polymer resin layer comprises acrylic resin or epoxy resin.

5. The transparent conductive substrate of claim 1, wherein a difference in reflectance between the pattern part and the non-pattern part is 1% or less.

6. The transparent conductive substrate of claim 1, having a light absorptance of 5% or less.

7. The transparent conductive substrate of claim 1, further comprising a planarization layer formed between the first thin film and the metal thin film, the planarization layer planarizing the first thin film.

8. The transparent conductive substrate of claim 7, wherein the planarization layer comprises ZnO, a thickness of the planarization layer ranging from 3 to 7 nm, a total thickness of the first thin film and the planarization layer ranging from 30 to 50 nm.

9. The transparent conductive substrate of claim 1, further comprising an anti-oxidation layer formed between the metal thin film and the second thin film, the anti-oxidation layer preventing the metal thin film from being oxidized.

10. The transparent conductive substrate of claim 9, wherein the anti-oxidation layer comprises ZnO, a thickness of the anti-oxidation layer ranging from 3 to 7 nm, and a total thickness of the second thin film and the anti-oxidation layer ranging from 30 to 50 nm.

11. A touch panel comprising the transparent conductive substrate recited in claim 1.
